(19) United States
(12) Patent Application Publication
(10) Pub. No.: US 2026/0045382 A1
(43) Pub. Date: Feb. 12, 2026

(54) METHODS AND APPARATUS FOR IONIZING BLOWERS HAVING ANGLED/ROTATABLE COLLIMATION

(71) Applicant: Illinois Tool Works Inc., Glenview, IL (US)

(72) Inventors: Aleksey Klochkov, San Francisco, CA (US); Juan Guerrero, Berkeley, CA (US); Edward Oldynski, Martinez, CA (US); Steven Bernard Heymann, Los Gatos, CA (US)

(21) Appl. No.: 19/293,430

(22) Filed: Aug. 7, 2025

Related U.S. Application Data
(60) Provisional application No. 63/681,308, filed on Aug. 9, 2024.

(51) Int. Cl. G21K 1/02; F24F 8/30; H01T 23/00

(52) U.S. Cl. CPC G21K 1/02; F24F 8/30; H01T 23/00

(57) ABSTRACT

Disclosed example angled collimators for ionizing blowers include: a collimator body comprising at least one of a truncated cone or a truncated pyramid, the collimator body having a first opening and a second opening, wherein the second opening is not parallel with the first opening; and a baffle within the collimator body and oriented transverse to both the first opening and the second opening.

### RELATED APPLICATIONS

The present application claims the benefit of U.S. Provisional Patent Application Ser. No. 63/681,308, filed Aug. 9, 2024, entitled “METHODS AND APPARATUS FOR IONIZING BLOWERS HAVING ANGLED/ROTATABLE COLLIMATION. ” The entirety of U.S. Provisional Patent Application Ser. No. 63/681,308 is expressly incorporated herein by reference.

### FIELD OF THE DISCLOSURE

This disclosure relates generally to ionization, and more particularly, to methods and apparatus for ionizing blowers having angled/rotatable collimation.

### BACKGROUND

Ion emitters of charge neutralizers generate and supply both positive ions and negative or AC ions into the surrounding air or gas media. To generate gas ions, the amplitude of the applied voltage must be high enough to produce a corona discharge between at least two electrodes arranged as an ionization cell. In the ionization cell, at least one electrode is an ion emitter and another one may be a reference electrode.

### SUMMARY

Methods and apparatus for ionizing blowers having angled/rotatable collimation are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example ionizing blower, in accordance with aspects of this disclosure.

FIG. 2 illustrates the ionizing blower of FIG. 1 having an angled collimator with a baffle attached to a body of the ionizing blower, in accordance with aspects of this disclosure.

FIG. 3A illustrates a front view of the example ionizing blower and angled collimator with a baffle of FIG. 2.

FIG. 3B illustrates a top plan view of the example ionizing blower and angled collimator with a baffle of FIG. 2.

FIG. 3C illustrates a side elevation view of the example ionizing blower and collimator with a baffle of FIG. 2.

FIG. 4A illustrates a front elevation view of the example collimator of FIG. 2, including the collimator body and a baffle.

FIG. 4B illustrates a front right side elevation view of the example angled collimator with the baffle of FIG. 2.

FIG. 4C illustrates a rear view of the example angled collimator with the baffle of FIG. 2.

FIGS. 5A-5D illustrate views of the example baffle of FIGS. 4A-4C, in accordance with aspects of this disclosure.

FIG. 6A illustrates an example mounting bracket that may be used to secure the angled collimator of FIG. 2 to a body of the ionizing blower, in accordance with aspects of this disclosure.

FIG. 6B illustrates the example mounting bracket of FIG. 6A engaged with one of a set of notches to secure the angled collimator against rotation with respect to the body of the ionizing blower, in accordance with aspects of this disclosure.

FIGS. 7A-7C illustrate front views of the example ionizing blower of FIG. 2, in which the angled collimator is secured at different rotational positions to direct ionized airflow in corresponding directions with respect to the ionizing blower.

FIGS. 8A and 8B illustrate another example ionizing blower having multiple ionized airflow streams, and corresponding angled collimators attached to the ionizing blower to direct the ionized airflow streams in different arrangements.

The figures are not necessarily to scale. Wherever appropriate, similar or identical reference numerals are used to refer to similar or identical components.

### DETAILED DESCRIPTION

Ionizers, or charge neutralizers, emit positive and/or negative ions, or AC, to discharge static electricity that may be present on a surface or substrate, such as in a manufacturing facility. Ionizing blowers provide an airflow to direct the ions a further distance than the ions would reach without the airflow, which increases an effective range of the ionizing blower and increases the flexibility of placement of the ionizing blower. Disclosed example methods and apparatus for charge neutralization can be used in cleanroom production environments, and are particularly useful for semiconductor chip manufacturing.

Conventional ionizing blowers direct the airflow substantially directly outward from an airflow outlet of the ionizing blower. Once the ionizing airflow has been output from conventional ionizing blowers, the ionizing airflow tends to increase in area, which can be undesirable when a concentration of ions is desired on a particular area or position.

Disclosed example angled collimators and ionizing blowers having angled collimators improve the flexibility of positioning of ionizing blowers by allowing the redirection of the output to any angle, directing and focusing the ionizing airflow generated by the ionizing blower using a collimator, with or without a baffle. In contrast with conventional collimators, disclosed example angled collimators change the direction of the ionizing airflow exiting the ionizing blower in addition to reducing the coverage area and increasing the ion density of the ionizing airflow.

The terms “ionization” and “charge neutralization” are used interchangeably in this document.

According to some aspects of the disclosure, example angled collimators for ionizing blowers include: a collimator body comprising at least one of a truncated cone, a truncated pyramid, an oblique cylinder, or an oblique geometry having a polygonal base, the collimator body having a first opening and a second opening, wherein the second opening is not parallel with the first opening; and a baffle within the collimator body and oriented transverse to both the first opening and the second opening.

In some example angled collimators, the collimator body further includes a flange adjacent the first opening. Some example angled collimators further include a mounting bracket configured to retain the collimator body against a surface via retention of the flange. In some example angled collimators, the flange includes a plurality of notches, and the mounting bracket includes a protrusion configured to extend into one of the notches to resist rotation of the collimator body in the installed position. In some example angled collimators, the notches are spaced at regular intervals around a circumference of the flange.

In some example angled collimators, the collimator body further includes a cylindrical section between the first opening and the flange. In some example angled collimators, the baffle includes three or more segments, in which each of the segments is oriented transverse to both the first opening and the second opening. In some example angled collimators, the three or more segments intersect along an intersection line extending between the first open side and the second open side of the collimator body. In some example angled collimators, the three or more segments are angularly spaced around a circumference of an internal surface of the collimator body, and none of the three or more segments is aligned with the point on the second opening at which the shortest distance between the second opening and the first opening is located.

In some example angled collimators, the collimator is configured to aim and focus an airflow entering the first open side and exiting the second open side. In some example angled collimators, the second open side has a smaller area than the second open side. In some example angled collimators, the collimator body includes an oblique truncated cone or an oblique truncated pyramid.

According to some aspects of the disclosure, example ionizing blowers include: a body; a blower configured to induce an airflow through the body and direct the airflow toward an outlet on the body; an ion emitter configured to emit ions within the airflow; and an angled collimator coupled to the body adjacent the outlet of the body, in which the collimator is configured to focus the airflow and redirect the airflow in a different direction than a direction of the outlet.

In some example ionizing blowers, the angled collimator includes: a collimator body includes at least one of a truncated cone or a truncated pyramid, in which the collimator body has a first opening and a second opening, and the second opening is not parallel with the first opening, and the first opening is adjacent the outlet of the body; and a baffle within the collimator body and oriented transverse to both the first opening and the second opening. Some example ionizing blowers further include a mounting bracket configured to retain the collimator body against a surface via retention of the flange.

In some example ionizing blowers, the flange includes a plurality of notches, and the mounting bracket comprises a protrusion configured to extend into one of the notches to resist rotation of the collimator body in the installed position. In some example ionizing blowers, the notches are spaced at regular intervals around a circumference of the flange.

According to some aspects of the disclosure, example ionizing blowers include: a body; a plurality of blowers configured to induce a plurality of separate airflows through the body and direct the separate airflows toward respective outlets on the body; a plurality of ion emitters configured to emit separate streams of ions within the separate airflows; and a plurality of angled collimators coupled to the body adjacent the respective outlets of the body, the angled collimators configured to focus the respective airflows and redirect each the respective airflows in a different direction than a direction of the corresponding outlet.

In some example ionizing blowers, each of the plurality of angled collimators includes: a collimator body having at least one of an oblique truncated cone or an oblique truncated pyramid, the collimator body having a first opening and a second opening, wherein the second opening is not parallel with the first opening, and the first opening is adjacent the corresponding outlet of the body; and a baffle within the collimator body and oriented transverse to both the first opening and the second opening. In some example ionizing blowers, the plurality of collimators are separately adjustable to aim the corresponding airflow.

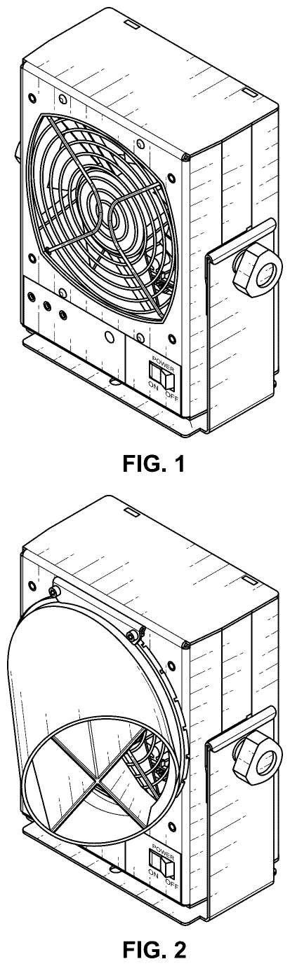

FIG. 1 is a view of an example ionizing blower 100. The ionizing blower 100 includes a body 102 that holds a blower (e.g., a fan) configured to blow a stream of air through an air path. The air path may flow from an outlet 104 on the body 102. As described in more detail below, the ionizing blower 100 includes ion emitters that emit positive and/or negative ions, or AC, and the fan blows the stream of air over the ion emitters, which results in a neutralization of electric charge that may be present in the output air stream or target area or product.

While examples disclosed below are described with reference to a DC corona ionizer, aspects of this disclosure may additionally or alternatively be used with an AC corona ionizer and/or a combination AC/DC corona ionizer.

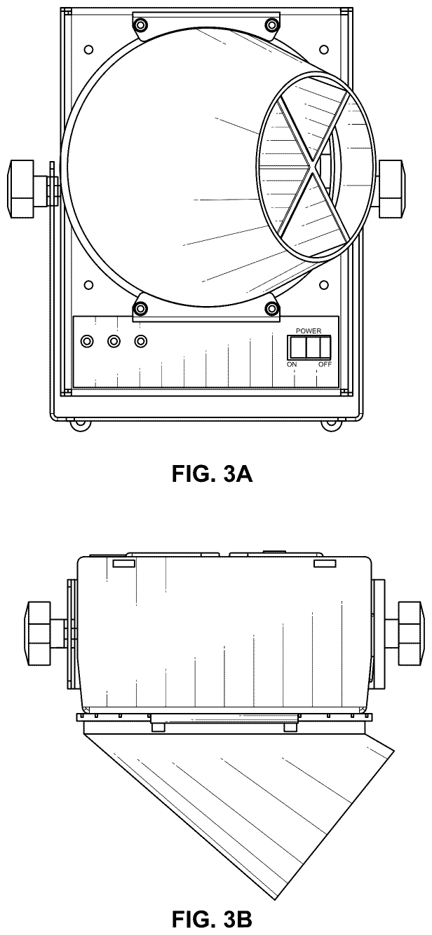

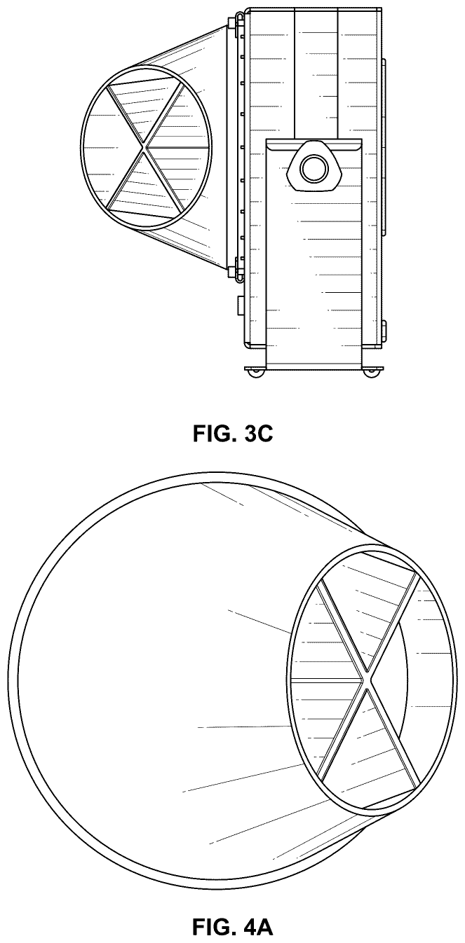

FIG. 2 illustrates the ionizing blower 100 of FIG. 1 having a angled collimator 110 attached to the body 102 of the ionizing blower 100. FIG. 3A illustrates a front view of the example ionizing blower 100 and angled collimator 110 of FIG. 2. FIG. 3B illustrates a top plan view of the example ionizing blower 100 and angled collimator 110 of FIG. 2. FIG. 3C illustrates a side elevation view of the example ionizing blower 100 and angled collimator 110 of FIG. 2. As disclosed in more detail below, the angled collimator 110 includes a collimator body 112 and a baffle 114. The example angled collimator 110 is fluidly coupled to the outlet 104, and redirects the airflow from a first direction (e.g., a direction of the outlet 104) to a second direction (e.g., a direction output from the angled collimator 110).

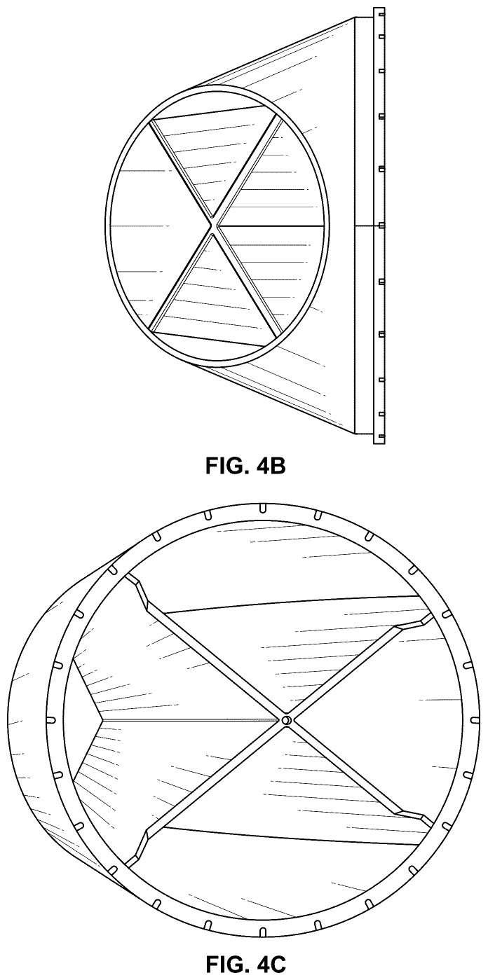

FIG. 4A illustrates a front elevation view of the example angled collimator 110 of FIG. 2. including the collimator body 112 and the baffle 114. FIG. 4B illustrates a front right side elevation view of the example angled collimator 110, and FIG. 4C illustrates a rear view of the example angled collimator 110. As illustrated in FIGS. 4A-4C, the example collimator body 112 has a first section 116 shaped as a truncated cone. In particular, the illustrated example first section 116 of the collimator body 112 is a truncated oblique cone.

In other examples, the first section 116 of the collimator body 112 may be a truncated pyramid (e.g., a truncated oblique pyramid) having a base with the shape of any desired regular polygon, an oblique cylinder, or an oblique geometry having any regular polygonal base.

The collimator body 112 has a first opening 118 (e.g., an inlet opening) and a second opening 120 (e.g., an outlet opening). The example first opening 118 is parallel to a base plane of the truncated oblique cone of the first section 116. The second opening 120 corresponds to an intersecting plane that intersects the first section 116 of the collimator body 112 and intersects the base plane of the truncated oblique cone. Accordingly, the first opening 118 is not parallel to the second opening 120. The second opening 120 has a smaller area than the first opening 118, which aids in focusing the ionizing airflow entering the first opening 118 and exiting the second opening 120.

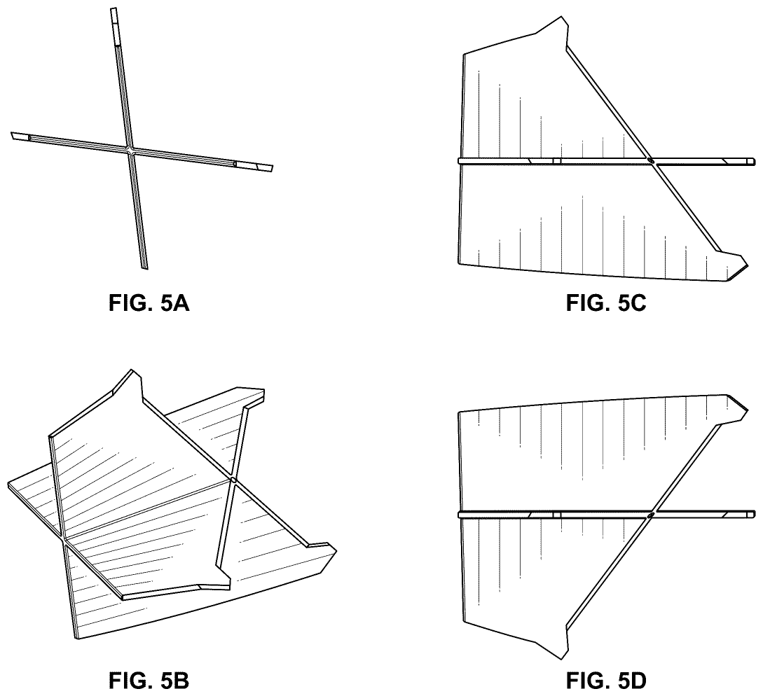

The example baffle 114 is positioned within the collimator body 112 between the first opening 118 and the second opening 120. FIGS. 5A-5D illustrate views of the example baffle of FIGS. 4A-4C.

The baffle 114 includes multiple segments 122a-122d. The example segments 122a-122d intersect along an intersection line 124, and extend radially towards an internal surface 126 of the collimator body 112. The example segments 122a-122d are spaced at the same or different angular intervals around an interior of the circumference of the collimator body 112. The intersection line 124 may be identical with a body centerline connecting the center of the first opening 118 and the center of the second opening 120. Additionally or alternatively, the intersection line 124 may be angularly offset and/or linearly offset from the centerline. For example, the intersection line 124 may be angularly offset from the centerline up to 5 degrees and, in some examples, up to 1.5 degrees, and/or linearly offset from the centerline up to 0.5 inches.

In the example of FIGS. 4A-4C, the segments 122a-122d of the baffle 114 are arranged such that none of the segments 122a-122d is aligned with the point 128 on the second opening 120 at which the distance between the second opening 120 and the first opening 118 (e.g., along the surface of the collimator body 112) is the shortest (e.g., line 130 in FIG. 3C). In the illustrated example, the point 128 is positioned between (e.g., half-way between) two of the segments 122a, 122b.

While the example baffle 114 includes four segments 122a-122d, the baffle 114 may include three segments, five segments, six segments, or more segments in other examples. Additionally or alternatively, the segments 122a-122d of the baffle 114 may be arranged with different spacings within the interior of the collimator body 112.

Returning to FIGS. 4A-4C, the example collimator body 112 further includes a second section 132 adjacent the first section 116 at the first opening 118. The second section 132 has a cylindrical shape in the example of FIGS. 4A-4C, but may have a different shape corresponding to a shape of the base of the first section 116. In the example of FIGS. 4A-4C, the second section 132 may have a height (or length) of 0.25-0.5 inches. However, the height of the second section 132 may be more or less, or the second section 132 may be omitted.

As illustrated in FIG. 5, the segments 122a-122d have angled sections 134a-134d that accommodate the change in direction of the surface of the collimator body 112 from the first section 116 to the second section 132, and abut an interior surface of the second section 132 of the collimator body 112.

The example collimator body 112 further includes a flange 136 adjacent the first opening 118. The example flange 136 extends around a circumference of the collimator body 112, and may include a seal to reduce or prevent leakage of the ionizing airflow between the angled collimator 110 and the body 102 of the ionizing blower 100.

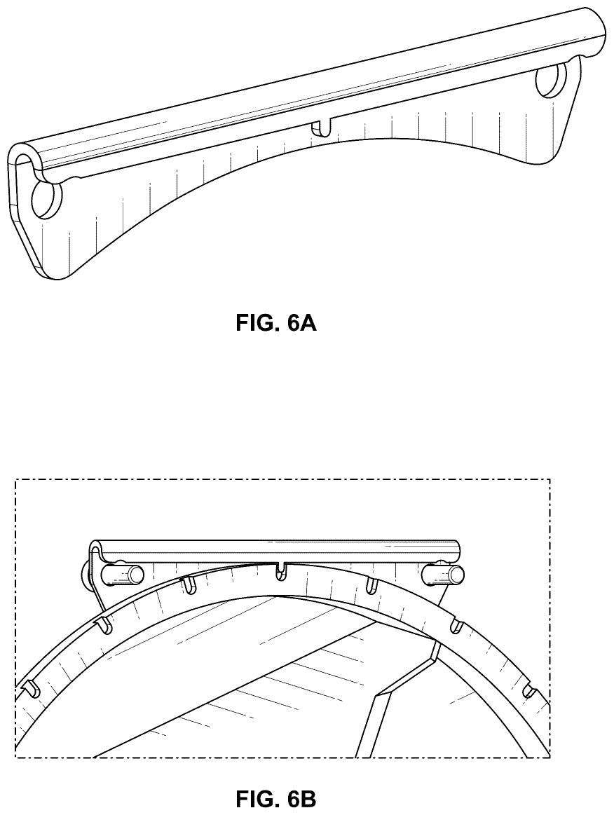

FIG. 6A illustrates an example mounting bracket 138 that may be used to secure the angled collimator 110 of FIG. 2 to the body 102 of the ionizing blower 100. The angled collimator 110 may be removably attached to the body 102 of the ionizing blower 100 via one or more mounting brackets 138. In the example of FIG. 3A, the angled collimator 110 is coupled to the body 102 via a first mounting bracket 138a on a first side (e.g., top) of the angled collimator 110 and a second mounting bracket 138b on a second side (e.g., opposite, below) of the angled collimator 110.

The example mounting brackets 138 are fastened to the body 102 using one or more fasteners, and hold the flange 136 against the body 102 when secured via the fasteners. However, in other examples, the mounting brackets 138 may secure the angled collimator 110 to the body 102 using other techniques, such as using clamps, clips, and/or any other technique.

The example flange 136 and/or the mounting bracket 138 further include an anti-rotation feature to reduce or prevent rotation of the angled collimator 110 with respect to the body 102 of the ionizing blower 100 while the angled collimator 110 is secured to the body 102 via the mounting bracket 138. FIG. 6B illustrates the example mounting bracket 138 of FIG. 6A engaged with one of a set of notches 602 to secure the angled collimator 110 against rotation with respect to the body 102 of the ionizing blower 100. The example flange 136 includes the set of notches 602 to permit fixing of the direction of the ionizing airflow. In the example of FIG. 6B, the flange 136 includes notches spaced 15° about the circumference of the flange 136. In other examples, the flange includes more or fewer notches 602, and/or the notches may be spaced at different regular and/or irregular intervals. For example, the notches 602 may be grouped at a higher angular concentration in some sections of the circumference of the flange 136, and grouped at a lower angular concentration in other sections of the circumference of the flange 136.

To reduce or prevent rotation of the angled collimator 110, the example mounting bracket 138 includes a protrusion 604 (e.g., a tab) that extends into, or otherwise engages, a selected one of the notches 602 when the mounting bracket 138 is secured to the body 102. Without the notches 602 or another anti-rotation feature, the angled collimator 110 may rotate within the mounting brackets 138, causing the ionizing airflow to be directed in an unintended and/or undesired direction.

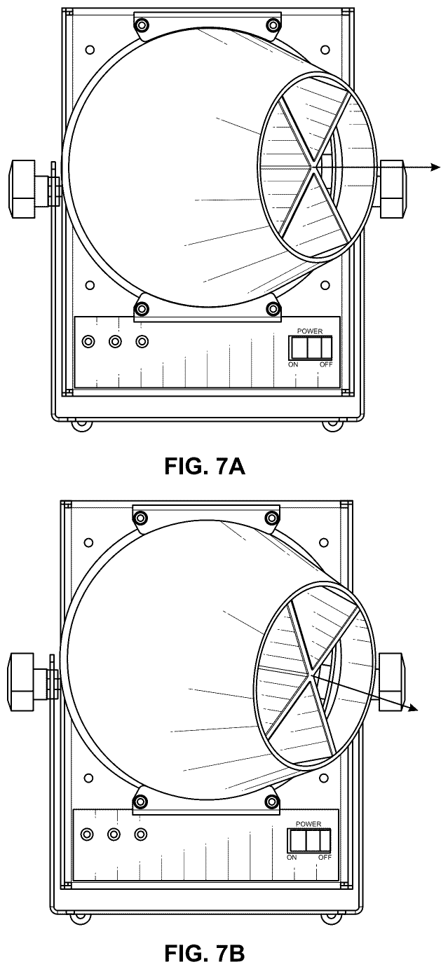

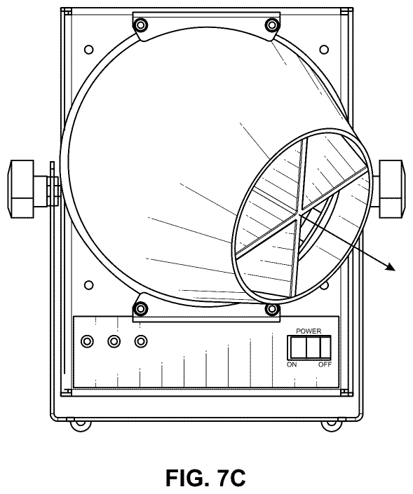

By removing the mounting bracket 138, the example angled collimator 110 may be oriented with respect to the body 102 to direct or aim the ionizing airflow in a desired direction, which is different than the direction of the outlet 104. FIGS. 7A-7C illustrate front views of the example ionizing blower 100 of FIG. 2, in which the angled collimator 110 is secured at different rotational positions to direct ionized airflow in corresponding directions 702, 704, 706 with respect to the ionizing blower 100.

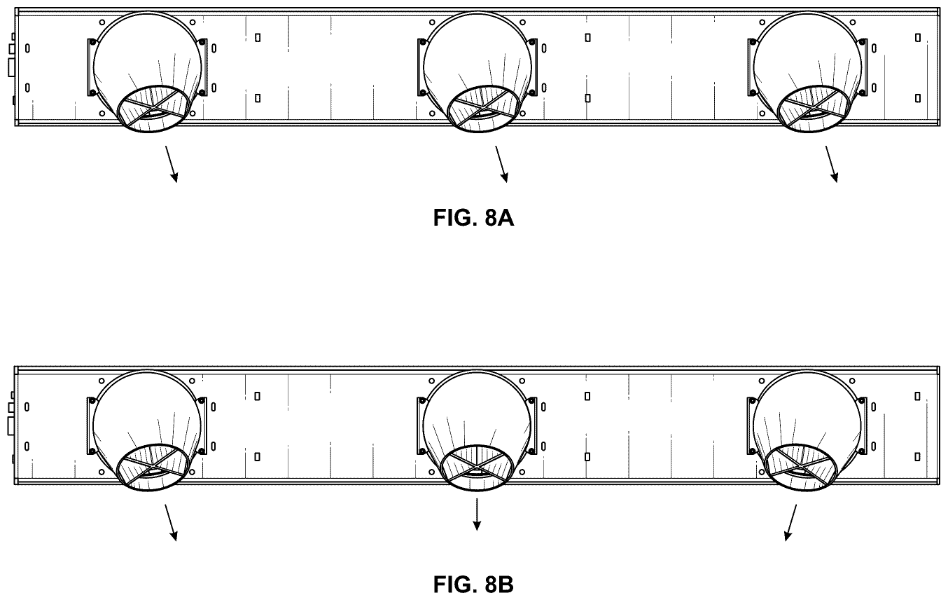

FIGS. 8A and 8B illustrate another example ionizing blower 800 having multiple ionized airflow streams 802a-802c, 804a-804c, and corresponding angled collimators 806a-806c attached to the ionizing blower 800 to direct the ionized airflow streams 802a-802c, 804a-804c in different arrangements. The example ionizing blower 800 includes one or more ion generators to generate one or more ion streams, and one or more airflow generators to generate the ionized airflow streams 802a-802c, 804a, 804c. The ionizing blower 800 includes three outlets from which the ionized airflow streams 802a-802c, 804a-804c are emitted. Each of the outlets of the ionizing blower 800 are covered in the views of FIGS. 8A and 8B by respective angled collimators 806a, 806c.

The example ion generators, the airflow generators, the outlets, and/or the angled collimators 806a-806c may be similar or identical to, or different from, the ion generator, the airflow generator, the outlet, and/or the angled collimator 110 of FIGS. 2-7C. In the illustrated example, each of the angled collimators 806a-806c is the same as the example angled collimator 110 disclosed above, but may be modified or adapted according to any of the variations disclosed herein. The example angled collimators 806a-806c may be attached to a body 808 of the ionizing blower 800 using corresponding mounting brackets 810a-810f, which may be similar or identical to, or different from, the mounting bracket 138 of FIGS. 6A and 6B.

The example angled collimators 806a-806c may be oriented independently of each other to direct the different ionized airflow streams in the desired direction(s). In the example of FIG. 8A, the ionized airflow streams 802a-802c are directed in parallel directions by orienting the angled collimators 806a-806c. Conversely, in the example of FIG. 8B, the ionized airflow streams 804a-804c are directed in non-parallel directions, but may be directed towards a same location or area by orienting the angled collimators 806a-806c.

As utilized herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y and z.” As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. An angled collimator for an ionizing blower, the collimator comprising:
a collimator body comprising at least one of a truncated cone, a truncated pyramid, an oblique cylinder, or an oblique geometry having a polygonal base, the collimator body having a first opening and a second opening, wherein the second opening is not parallel with the first opening; and
a baffle within the collimator body and oriented transverse to both the first opening and the second opening.

2. The angled collimator as defined in claim 1, wherein the collimator body further comprises a flange adjacent the first opening.

3. The angled collimator as defined in claim 2, further comprising a mounting bracket configured to retain the collimator body against a surface via retention of the flange.

4. The angled collimator as defined in claim 3, wherein the flange comprises a plurality of notches, and the mounting bracket comprises a protrusion configured to extend into one of the notches to resist rotation of the collimator body in the installed position.

5. The angled collimator as defined in claim 4, wherein the notches are spaced at regular intervals around a circumference of the flange.

6. The angled collimator as defined in claim 1, wherein the collimator body further comprises a cylindrical section between the first opening and the flange.

7. The angled collimator as defined in claim 1, wherein the baffle comprises three or more segments, each of the segments oriented transverse to both the first opening and the second opening.

8. The angled collimator as defined in claim 7, wherein the three or more segments intersect along an intersection line extending between the first open side and the second open side of the collimator body.

9. The angled collimator as defined in claim 7, wherein the three or more segments are angularly spaced around a circumference of an internal surface of the collimator body, and none of the three or more segments is aligned with the point on the second opening at which the shortest distance between the second opening and the first opening is located.

10. The angled collimator as defined in claim 1, wherein the collimator is configured to aim and focus an airflow entering the first open side and exiting the second open side.

11. The angled collimator as defined in claim 1, wherein the second open side has a smaller area than the second open side.

12. The angled collimator as defined in claim 1, wherein the collimator body comprises an oblique truncated cone or an oblique truncated pyramid.

13. An ionizing blower, comprising:
a body;
a blower configured to induce an airflow through the body and direct the airflow toward an outlet on the body;
an ion emitter configured to emit ions within the airflow; and
an angled collimator coupled to the body adjacent the outlet of the body, the collimator configured to focus the airflow and redirect the airflow in a different direction than a direction of the outlet.

14. The ionizing blower as defined in claim 13, wherein the angled collimator comprises:
a collimator body comprising at least one of a truncated cone or a truncated pyramid, the collimator body having a first opening and a second opening, wherein the second opening is not parallel with the first opening, and the first opening is adjacent the outlet of the body; and
a baffle within the collimator body and oriented transverse to both the first opening and the second opening.

15. The ionizing blower as defined in claim 14, further comprising a mounting bracket configured to retain the collimator body against a surface via retention of the flange.

16. The ionizing blower as defined in claim 15, wherein the flange comprises a plurality of notches, and the mounting bracket comprises a protrusion configured to extend into one of the notches to resist rotation of the collimator body in the installed position.

17. The ionizing blower as defined in claim 16, wherein the notches are spaced at regular intervals around a circumference of the flange.

18. An ionizing blower, comprising:
a body;
a plurality of blowers configured to induce a plurality of separate airflows through the body and direct the separate airflows toward respective outlets on the body;
a plurality of ion emitters configured to emit separate streams of ions within the separate airflows; and
a plurality of angled collimators coupled to the body adjacent the respective outlets of the body, the angled collimators configured to focus the respective airflows and redirect each the respective airflows in a different direction than a direction of the corresponding outlet.

19. The ionizing blower as defined in claim 18, wherein each of the plurality of angled collimators comprises:
a collimator body comprising at least one of an oblique truncated cone or an oblique truncated pyramid, the collimator body having a first opening and a second opening, wherein the second opening is not parallel with the first opening, and the first opening is adjacent the corresponding outlet of the body; and
a baffle within the collimator body and oriented transverse to both the first opening and the second opening.

20. The ionizing blower as defined in claim 18, wherein the plurality of collimators are separately adjustable to aim the corresponding airflow.
